(19) United States
(12) Patent Application Publication
(10) Pub. No.: US 2025/0300395 A1
(43) Pub. Date: Sep. 25, 2025

(54) LATCHABLE ELECTRICAL WIRELINE WET CONNECTION

(71) Applicant: Sharewell HDD LLC, Houston, TX (US)

(72) Inventors: Kim Carrier, Houston, TX (US); Reid Caspary, Houston, TX (US)

(73) Assignee: Sharewell HDD LLC, Houston, TX (US)

(21) Appl. No.: 19/083,762

(22) Filed: Mar. 19, 2025

Related U.S. Application Data
(60) Provisional application No. 63/567,092, filed on Mar. 19, 2024.

(51) Int. Cl. H01R 13/625; E21B 47/12; H01R 13/52; H01R 43/26

(52) U.S. Cl. CPC H01R 13/625; E21B 47/12; H01R 13/5202; H01R 43/26

(57) ABSTRACT

A releasable and re-seat-able locking electrical wireline wet connection associated with sections of wireline used in an HDD drill string in a borehole. Said connection comprising a male member on one end of the wireline section having an externally exposed electrical contact receptacle that connects to a subsequent wireline section by mating and locking on to the female member. Mating is achieved by a simple “J”-shaped set of latching features, a second axis having a conductive part extending into a hollow body whereby the electrical contact element is fastened to the wireline coaxial center conductor for electrical continuity and with the wireline's protective armor also physically secured inside the hollow body for extreme mechanical and electrical integrity during the HDD drilling process. Reliable electrical connections are established and maintained notwithstanding wet and contaminated contacts and continuous rotation and wireline tension.

### CROSS REFERENCE TO RELATED APPLICATIONS

This application claims priority to U.S. Provisional Patent Application Ser. No. 63/567,092, filed on Mar. 19, 2024.

### BACKGROUND OF INVENTION

### Field of Use

The present invention provides an improved apparatus and method for making secure electrical wireline connections to provide power and electrical signals, including to and from downhole electrical tooling in a borehole. In one preferred embodiment, the invention is used as part of a horizontal directional drilling system for electrically controlling a steering tool while drilling a borehole. The disclosed apparatus and method provides improvements and efficiencies for making more reliable and more efficiently assembled and disassembled connections between such downhole electrical equipment and surface monitoring and data recording systems.

### Description of Related Art

### Horizontal Directional Drilling Process and Tooling

Horizontal directional drilling (HDD) is a steerable, trenchless drilling method used to install underground utilities such as pipelines, conduits or cables. HDD uses a drilling rig to create a pilot hole drilled horizontally from on point to another avoiding surface disruption and obstacles on the surface. During the drilling of the pilot hole, sections of drilling pipe are added to comprise the HDD drill string as the drill bit advances to a target point. Once the pilot hole is completed, the product is pulled through the borehole as the HDD drill string is “tripped” out of the hole with the product attached.

HDD and/or the drilling of horizontal or deviated wells uses survey tools, referred to as steering tools, to guide the drilling of the pilot hole to remain on its designated drill pathway to reach its target and to ensure that the hole is steered clear and away from underground obstacles. Such tools monitor the well bore path and monitor the orientation of the drilling assembly while the borehole is being drilled to its destination point. One method of transmitting these tool's survey information from the steering tool back to the surface for monitoring, and to power such tools, is by use of an electrical conductor wireline that is run through the HDD drill string as sections of drill pipe are added while the pilot hole is being drilled. The conductor wireline forms an electrical connection with the downhole steering tool and the surface equipment. The environment that the electrical connection encounters is frequently harsh, and the wireline and steering tool is surrounded by drilling fluid that is used to stabilize the borehole, and to lubricate and cool the cutting head and passage of the drill string.

The common usage of wireline in oil and gas exploration boreholes for establishing a connection to steering tools and other subsurface electrical equipment is due to its proven reliability over many decades. Typical examples of wireline applications are survey, and/or steering and logging tools requiring electrical connections to surface equipment. Such wirelines are generally routed from a reel on the surface through a pulley or sheave at the upper level of a drilling rig and may enter the drill string at the upper end, either through the rotary swivel, or other circulating head connections, down to the subsurface tool. The conveyance for the wireline in HDD applications, however, is fundamentally different in that the routing of wire pulled from the wire reel/spool must be fished through and spliced as each succeeding joint of drill pipe is added to the progression of the HDD drill string into the borehole.

During conventional HDD drilling, new electrical connections for the wire conductor must be spliced together for each new section of pipe added to the HDD drill string. The connections require wire unspooling from a wire reel, then fishing and splicing together the end of (usually plastic insulated 10-gauge copper) wire from the last joint in the drill string with a new length of insulated wire. This presents several problems for the reliability of the electrical connections. First, the mechanical and electrical integrity of new sections of wire connected to existing sections can vary as each new joint of drill pipe is added to the HDD drill string. In addition, the wire can become twisted with the rotation of the drill string in the hole, causing it to break and/or become entangled and restrictive to mud flow resulting in “wash” damage to the wire insulation. Additionally, the plastic insulated copper wire conventionally used in HDD is notorious for spontaneously breaking and shorting out during the drilling process, costing many rig-time and labor hours in pulling the drill string out of the borehole for wire repair and borehole remediation. Pulling the HDD drill string out of the borehole for repairing damaged electrical conductors in HDD operations is frequently the reason for economic losses on large projects. The commonly used wireline itself is susceptible to twisting and/or failure at any time, especially at the connection points at each joint of the HDD drill string. Accordingly, new methods and products are needed for efficiently connecting wireline segments and ensuring the mechanical and electrical integrity of those connections.

The instant J-lock connection invention relates generally to a releasable, reusable and re-seat-able electrical connection for conductors running through boreholes, and in the preferred embodiment to the connection of multiple wireline sections in an HDD borehole to maintain a very high reliability electrical interface with a downhole steering tool-connected to a surface receiver and power supply unit while drilling a borehole from start to finish. The present invention utilizes in a preferred embodiment a much less prone to failure mono-conductor braided wireline that has at least one electrical conducting strand, a coaxial insulation layer, which is surrounded by at least one layer of outer armor strands wound as a hard metal protective covering.

Drilling an HDD borehole utilizing the wireline with the instant J-lock connection invention differs in that lengths of wireline are prepositioned in the drill pipe sections to be added to the drill string as each joint is added, instead of the conventional wire unspooling, fishing, and splicing method mentioned above during the addition of drill pipe joints. To achieve this, the wireline end connection of the present invention contained within the drill string are rapidly connected and “locked” (via a j-lock connection) to facilitate the addition of joints to the drill string into the borehole. Retrieving the drill string and wireline sections out of the borehole is simply the reverse order of the borehole drilling process where the wireline connectors are rapidly “unlocked” and disconnected. The “armored” wireline sections are reusable, unlike the plastic covered wire traditionally used in HDD drilling operations.

When connected, the instant J-lock connection invention electrically isolates the electrical power and signal from electrical ground and from the drilling fluid encountered in the drill pipe. This allows unencumbered electrical communication between the steering tool and the surface equipment. Also, drill string rotation of steerable drilling assemblies does not twist and coil the electrical conductor, due to its construction design for swiveling and rotating operation. Furthermore, because of the present invention's “no wire-splicing” and mechanically robust design, the wireline segment ends can be quickly positioned inside the connections without needing ancillary support such as “spiders” etc. to reduce time in the addition of or subtraction of pipe joints.

### SUMMARY

The instant J-lock connection invention is directed to a releasable, re-seat-able and reusable electrical wireline connector apparatus used in the supplying of power and transmitting of electrical signals, including in a drill string, and includes co-acting and latch-able male and female member electrical connectors. Generically, such a connection may be referred to as an “electrical wet connection.” However, more specifically for HDD, the connection may be referred to as an “electrical wireline wet connection.” Both members include passageways for the flow of drilling fluids, while isolating those fluids from the co-acting male and female connections, and for effecting an insulating electrical seal against the medium or any ground source. The male member includes j-lock pins or tabs for making the latch-able connection with the female member and an electrical contact extending from the male member for connection to a corresponding contact internal to the female member, as well as support structure for the electrical conductors. Insulating seals are positioned surrounding the electrical contacts. Locking is achieved by a simple “J” shaped set of latching features.

A still further object of the invention is to provide strength, durability, precision, and positive electrical contact continuity through all electrical component parts while the wireline is subjected to high tension and torsion loads with wireline rotation and potentially wire damaging twisting events. The instant wireline conductor is allowed to swivel inside its cablehead housing even while the wireline is being pulled in tension or torsion through the drilling process. A low friction bearing sleeve component made of advanced composite materials houses a high-pressure feed-through-insulator contact pin and rubber insulated receptacle insert connection that allows the cable assembly to be rotated independently of the outer male and female component housings. Component parts can be easily removed, cleaned, and separately replaced, thus assuring absolute sealing and operation.

A still further object of the present invention is wherein a series of compression O-ring seals is positioned between the male member and female member for sealing on compression when the female and male members are connected, and the j-lock is latched. Additional or substitute types of seals can be provided.

Still further objects of the present invention are to provide a method for enhanced safety and efficiency in making electrical connections to high hazard risk downhole tools used in oil and gas exploration and production boreholes and to provide a method for faster tripping in and tripping out of electrically wired drill strings in mining, geotechnical, and HDD projects. These objects are achieved by providing a uniformly consistent, electrically secure and mechanically robust connection, as well as allowing for more rapid assembly, disassembly and reuse of the same, in comparison to the conventional means of fishing and splicing the wireline through each succeeding pipe joint and discarding the wireline afterward.

Other and further applications, objects, features and advantages will be apparent from the following description of presently preferred embodiments of the invention, given for the purpose of disclosure, and taken in conjunction with the accompanying drawings.

### BRIEF DESCRIPTION OF THE DRAWINGS

FIG. 1 is a schematic side view, illustrating drilling of an HDD drilled well.

FIG. 2 is a partly in cross-section view of the instant invention.

FIG. 3A is a view of the female member, partly in cross section, of the connector shown in FIG. 2.

FIG. 3B is a view of the male member, partly in cross section, of the connector shown in FIG. 2.

FIG. 4 is a perspective view of the female and male members shown in FIGS. 3A and 3B, before they are connected.

FIG. 5 is a perspective view of the female and male members shown in FIGS. 3A and 3B, as the male member is being inserted into the female member.

FIG. 6 is a perspective view of the female and male members shown in FIGS. 3A and 3B, as the male member is being inserted into the female member and the j-lock pins of the male member are lined up with the j-channel of the female member.

FIG. 7 is a perspective view of the female and male members shown in FIGS. 3A and 3B, as the j-lock pins of the male member enter the j-channel of the female member.

FIG. 8 is a perspective close-up view of the female and male members shown in FIGS. 3A and 3B, as the j-lock pins of the male member advance to the curved portion of the j-channel of the female member.

FIG. 9 is a perspective close-up view of the female and male members shown in FIGS. 3A and 3B, as the j-lock pins of the male member advance through the portion of the j-channel perpendicular to the axis of the female member.

FIG. 10 is a perspective close-up view of the female and male members shown in FIGS. 3A and 3B, as the j-lock pins of the male member further advance through the portion of the j-channel perpendicular to the axis of the female member.

FIG. 11 is a perspective close-up view of the female and male members shown in FIGS. 3A and 3B, as the j-lock pins of the male member advance to the end of the portion of the j-channel perpendicular to the axis of the female member.

FIG. 12 is a perspective close-up view of the female and male members shown in FIGS. 3A and 3B, as the j-lock pins of the male member advance towards the seat portion of the j-channel perpendicular to the axis of the female member.

FIG. 13 is a perspective close-up view of the female and male members shown in FIGS. 3A and 3B, as the j-lock pins of the male member advance to the channel's end and rest at the seat portion of the j-channel perpendicular to the axis of the female member.

FIG. 14 is a perspective close-up view of the female and male members shown in FIG. 13, rotated 45° upward.

FIG. 15 is a perspective close-up view of the female and male members shown in FIG. 13, rotated 90° upward.

FIG. 16 is a perspective view of the female and male members shown in FIG. 13, rotated 90°.

FIG. 17 is a perspective view of the female and male members shown in FIG. 13, rotated 180°.

Many aspects of the invention can be better understood with reference to the above referenced drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the detailed description that follows.

### DETAILED DESCRIPTION OF THE PREFERRED EMBODIMENTS

The instant invention of the releasable, reseatable and reusable electrical wireline connector for transmitting and receiving electrical signals to a sonde in a HDD drill string will be described in connection with a steering tool in HDD applications, for purposes of illustration only. However, it is to be understood that the instant J-lock connection invention can be used to conduct electrical signals and power through the conductor wireline in other applications as well.

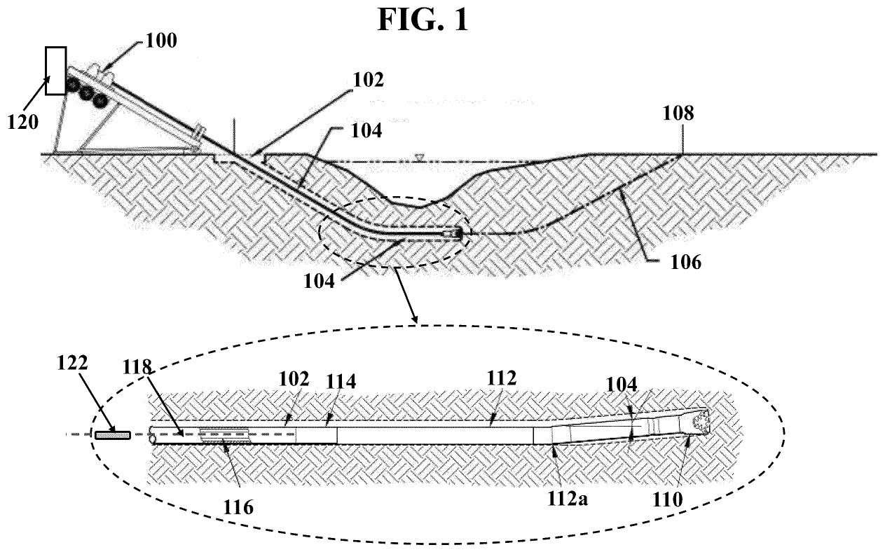

Referring now to the drawings, and particularly to FIG. 1, an HDD rig 100 is shown for operating an HDD drill string 102 for drilling a well bore 104. As shown, the well bore 104 to is that of a typical HDD well. In order to drill in a pre-determined directional path 106 to an exit point 108, a conventional downhole fluid drive motor or steerable motor 112 includes a drill bit 110 and is actuated by the flow of fluid down the inside of the drill string 102. The axis of the bit 110 is offset from the axis of the well bore 104. The steerable motor 112 is oriented in the required direction, and the drilling continues along the path 106 by fluid actuation of the motor 112 driving the bit 110.

In order to drill a horizontally directed well bore 104, the drill string 102 includes an orienting sub or sonde 114 and a steering tool 116 which is rotatably aligned with the steerable drilling motor 112 and motor housing 112a and is connected by a wireline electrical conductor 118 to a measurement unit at the surface 120. This apparatus and method is generally conventional. The present method and apparatus is directed to the improvement in connecting the wireline and electrical conductor 118 between the steering tool 116 and a wireline measurement unit 120 located at the surface near the HDD rig 100.

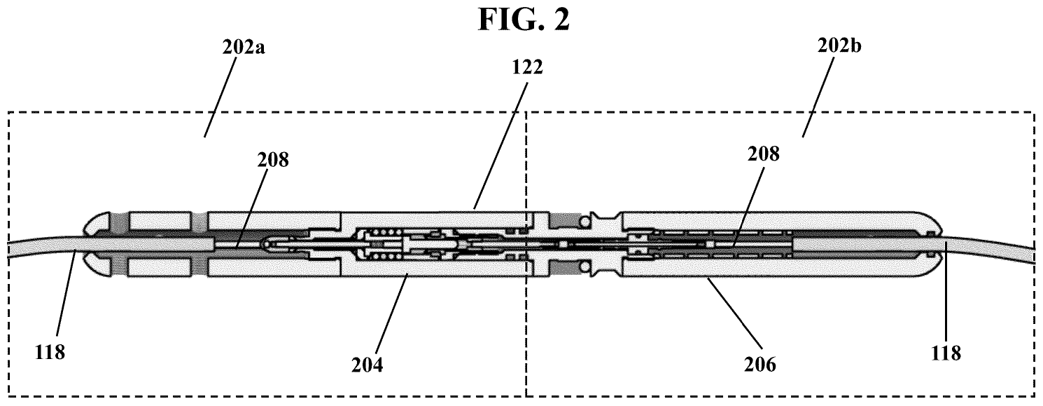

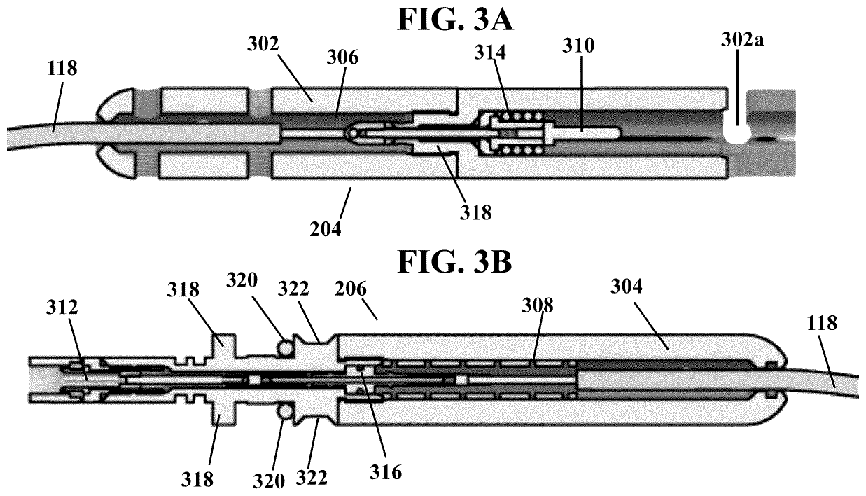

A plurality of electrical wireline connector units 122 (FIGS. 1 and 2) may be included to connect sections of the wireline and electrical conductor 118, as each section of wireline is fed into a joint of the HDD drill string 102. In order to establish electrical continuity and to transmit electrical signals between the steering tool 116 and the measurement unit 120, a plurality of electrical wet connecting units 122, each consisting of a female member 204 and a male member 206 (FIG. 2 and FIGS. 3A and 3B, respectively) are utilized.

Referring to FIG. 2, the electrical connection unit 122 is shown to be in the interior of two connected joints of drill pipe making up a portion of the HDD drill string (sizes are not proportional for purpose of illustration). Wireline conductors 118 enter through each distal end of the electrical conductor 122 where a coaxial cable rod 208 is in contact with additional connective components discussed below. When the female and male members 204 and 206, respectively, are connected together, as shown in FIG. 2, they form a coacting electrical “wet” connection communicatively coupling the ends of the wireline conductor together.

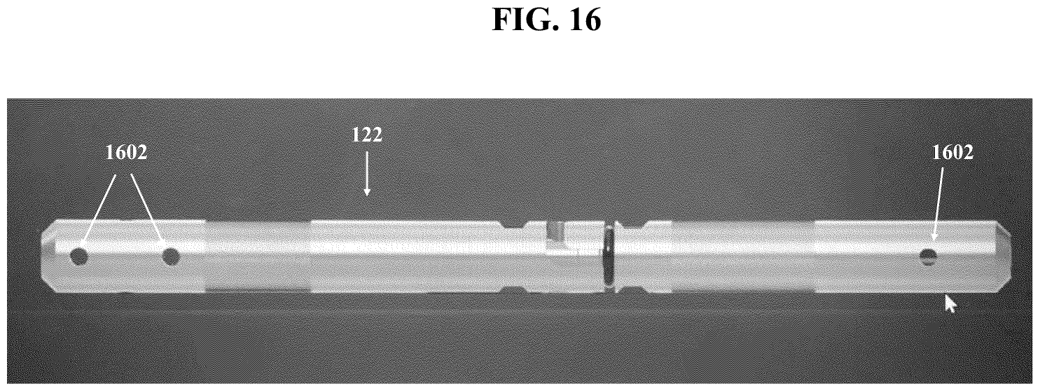

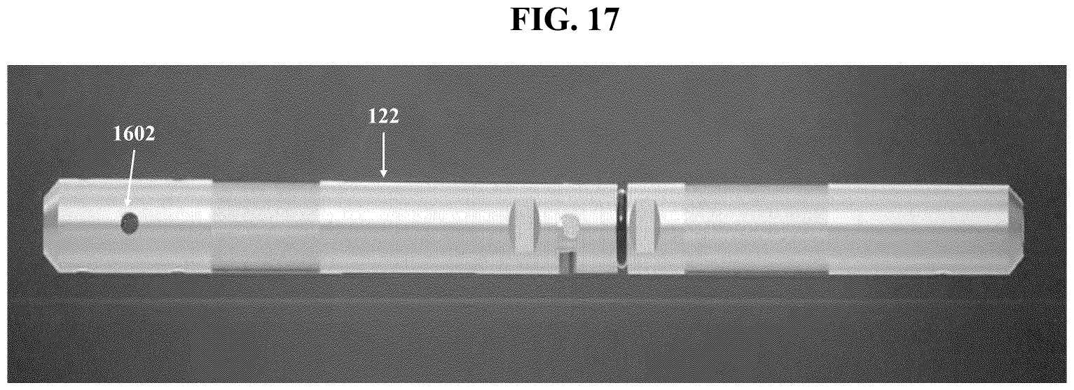

Referring to FIGS. 3A and 3B, the female and male members 204 and 206 each include a female and male outer cablehead housing, 302 and 304, respectively, made out of metal, including for example, stainless steel or similar alloy. Each member also has a hollow bore inner section 306 and 308, respectively, designed with conventional means to secure and receive the respective ends of the wireline conductors 118. The cablehead covers 302 and 304 may include holes for cable position locking set screws (see FIGS. 16 and 17). In a preferred embodiment, the female member 204 is attached to the end of the wireline conductor 118 opposing the subsurface tool. The wireline conductor 118 is connected to conductor rods 208 terminating at a radial contact receptacle and a banana pin pedestal, respectively, of the male and female members 206 and 204, and supported by various conventional feature, including in a preferred embodiment, O-ring insulators 314 within the bore of the female member's housing.

The wireline conductor 118 is allowed to freely swivel by conventional means inside its respective cablehead housings even while the wireline is being pulled in extreme tension as may be necessary for an instrumented sonde retrieval sticking in tight downhole conditions. Low friction bearing sleeve components 316 and 318 made of advanced composite materials allow for the cable assemblies 308 and 310, respectively, to be rotated independently of the outer female and male component cablehead housings 302 and 304. The female member 206 houses a high-pressure feed-through-insulator contact banana pin 310 and the male member 206 houses a rubber insulated banana pin receptacle 312, each coacting with the wireline conductor 118. Additionally, in the latched position, the female member contact pin 310 and male member insert receptacle 312 make spring-loaded face to face contact to achieve electrical contact redundancy for failsafe operation. All component parts can be easily removed, cleaned, and separately replaced, assuring absolute sealing and operation.

In the preferred embodiment, the male member includes an upstanding hollow bore shaft portion with beveled wrench flats 322, and two J-Lock pins 318 spaced 180° apart. The male member also includes an O-ring 320 positioned against a shoulder in the shaft portion immediately adjacent to the wrench flats 322. The hollow bore shafts of both the male member 206 and female member 204 include channels, respectively of sufficient diameter to allow passage of the conductive cable of an electrical conduit 118.

The male member's j-pins 318 are aligned with and inserted into the female members j-lock channels 302a and the male members receptacle end 312 is inserted into the female member's hollow bored end. As the male member receptacle 312 supported by insulators is inserted into the female member's hollow bore, the male member's j-pins 318 travel down to the end of the corresponding j-shaped channel 302a. Once the pins 318 reach the portion of the j-shaped channel 302a that is perpendicular to the center axis of the female member, at which time the respective banana pin and receptacle contacts have mated, the drill string worker uses a wrench secured to the wrench flats 322 to rotate the male member 206 to the pins 318 final j-lock position in the j-shaped channels 302a, latching the two members together.

### Connection and Latching of the Wireline Connector During Operation

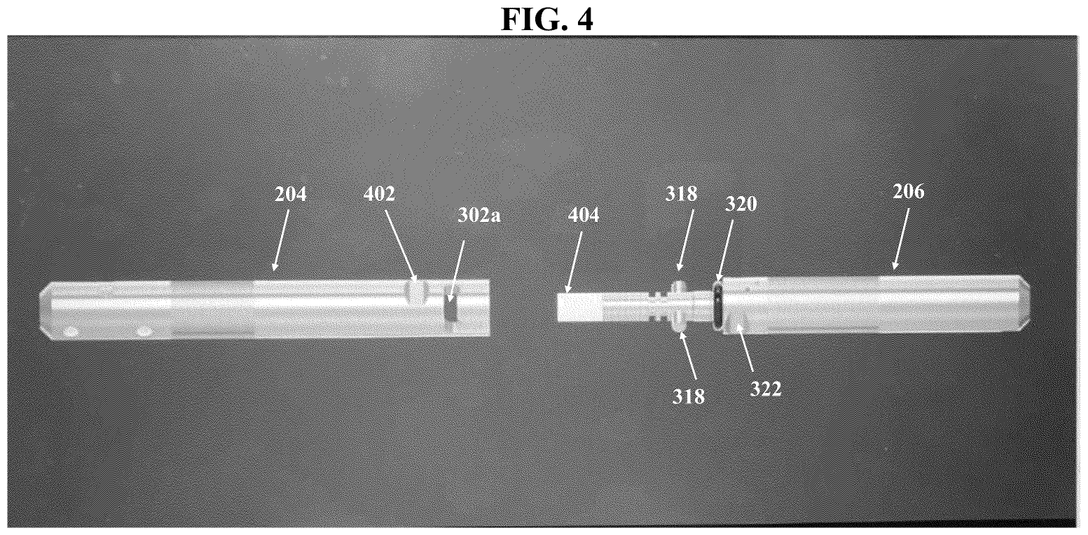

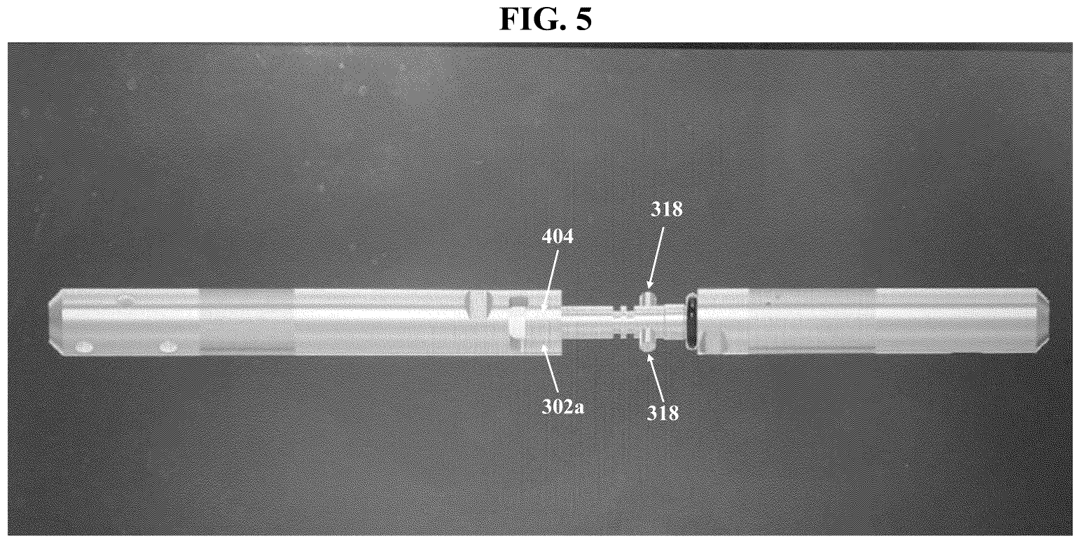

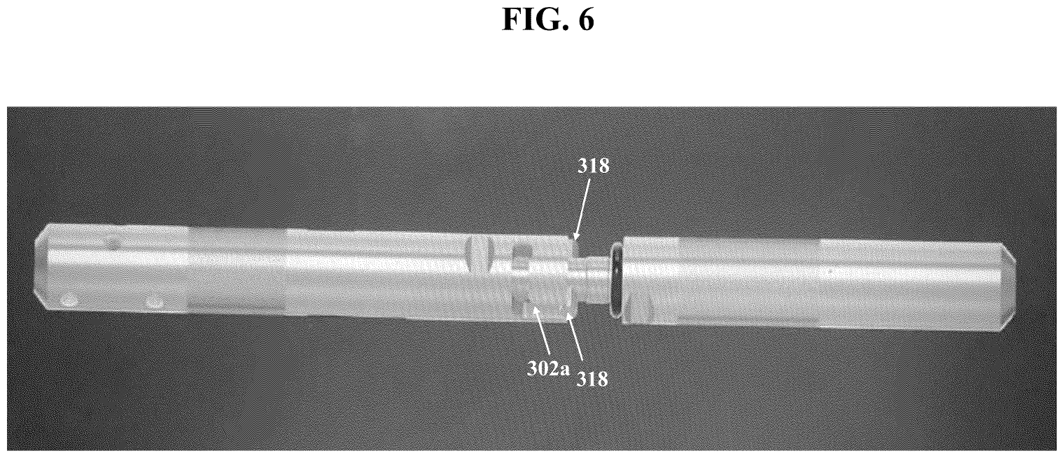

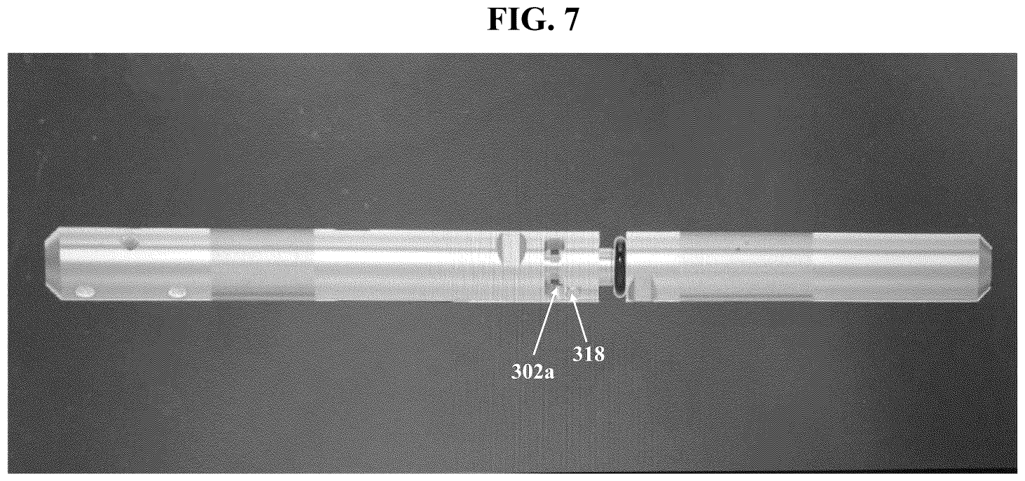

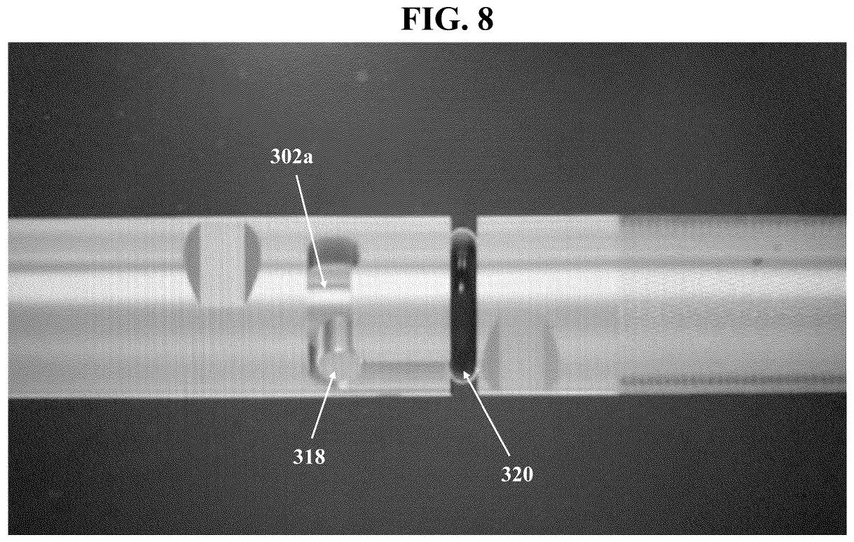

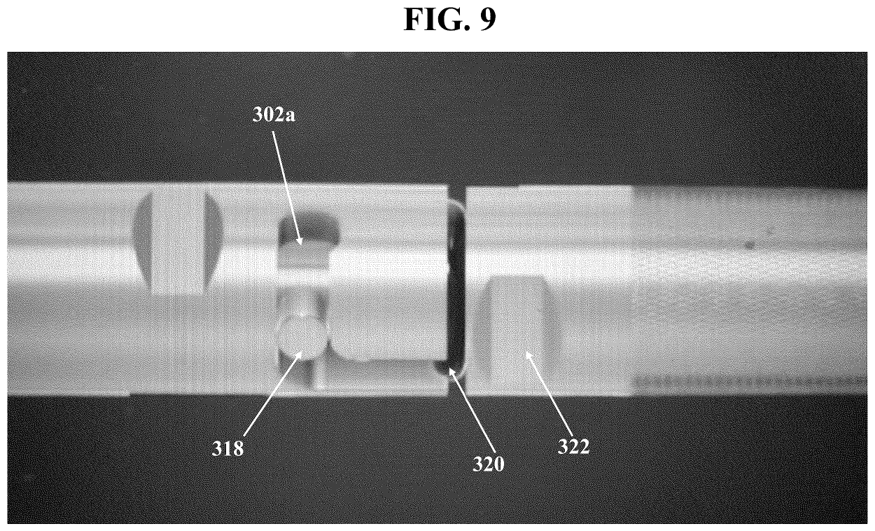

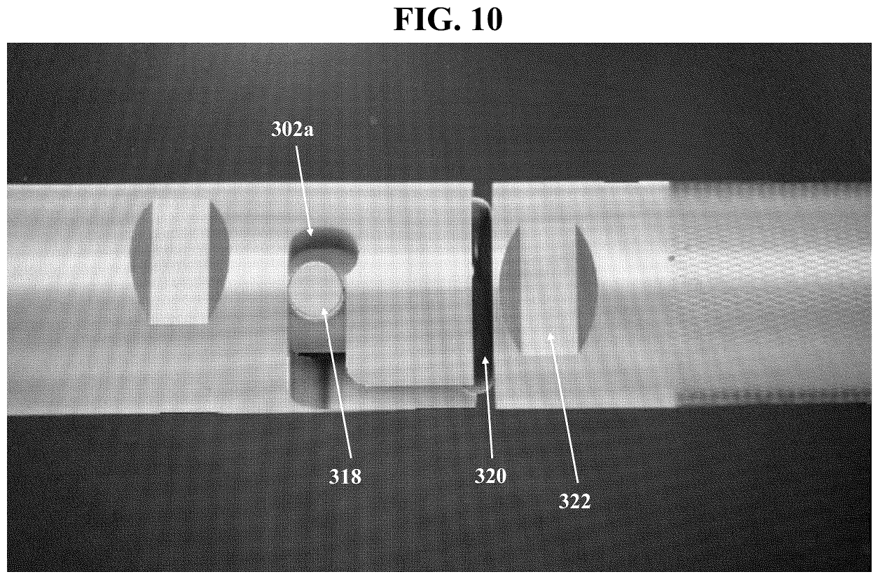

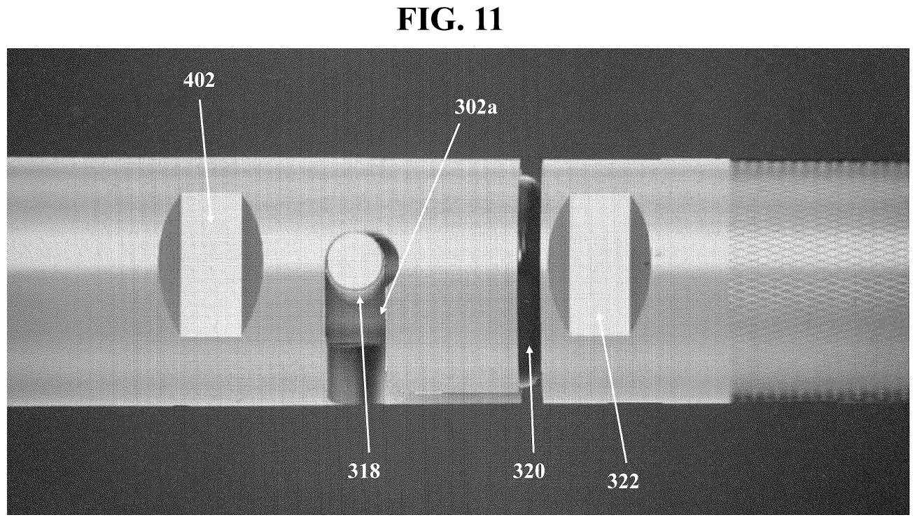

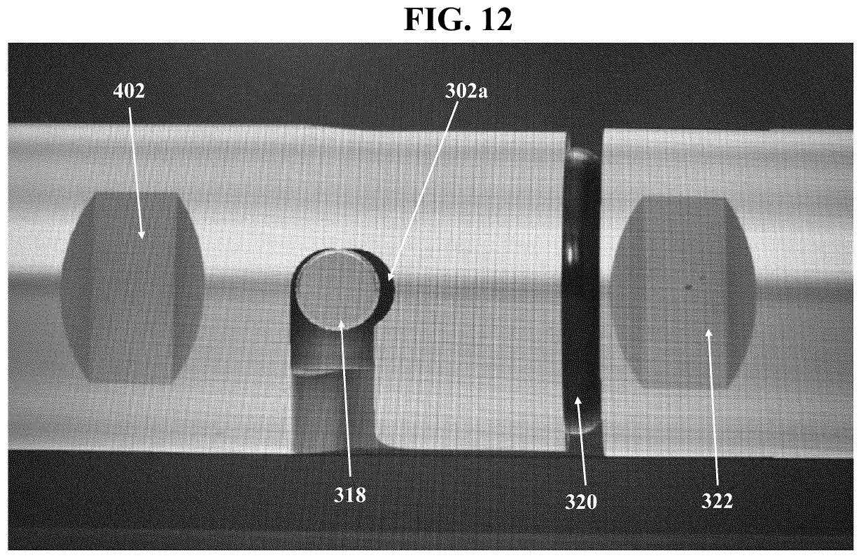

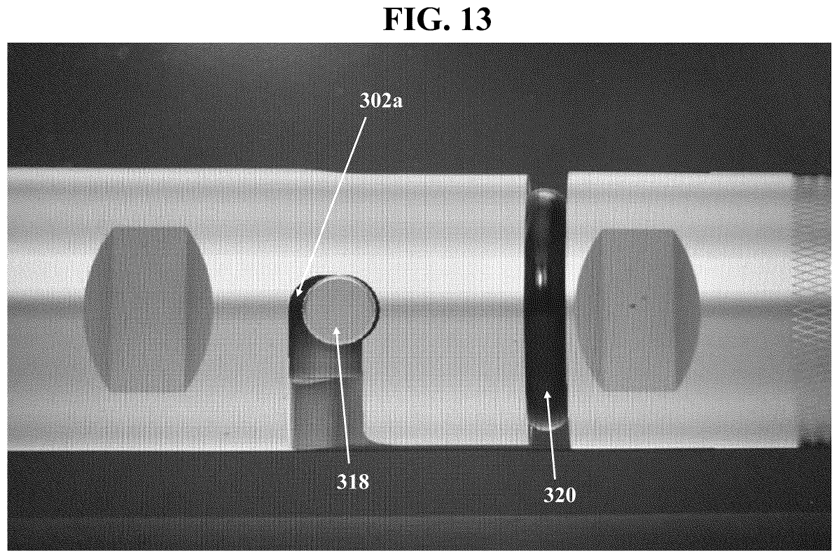

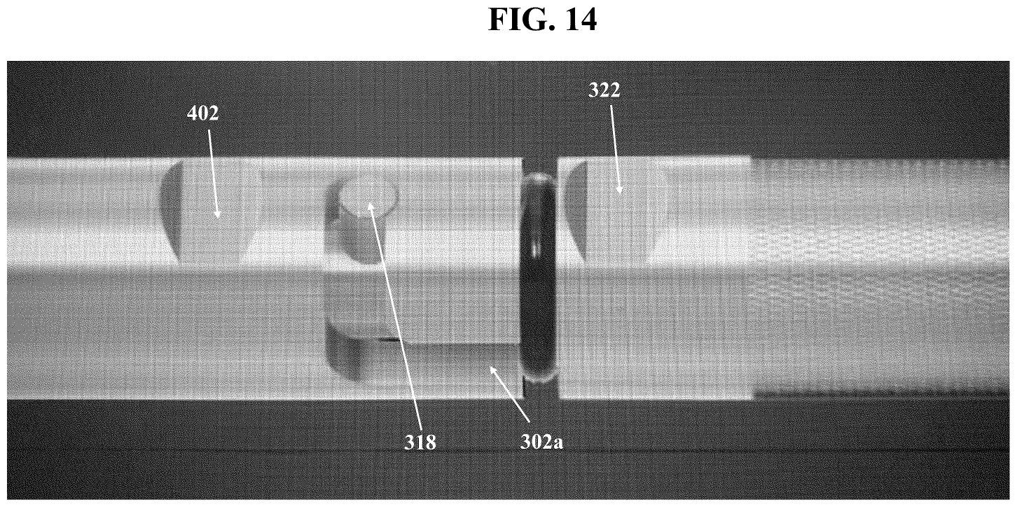

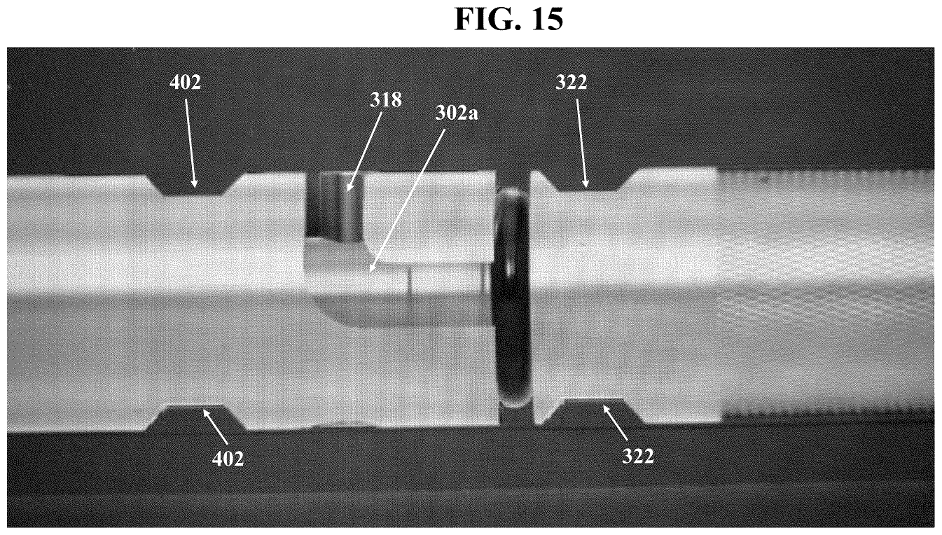

In operation, the male and female members of the connector are attached and locked together by the drill string operator as each new joint of pipe is added to the HDD drill string. FIGS. 4-13 depict that sequence of attachment. FIG. 4 illustrates that the male and female members 206 and 204, respectively, are aligned so that the contact insulator face of the male member 404 (which, in reference to FIG. 3B, houses the banana pin receptacle 312 adapted to coact with the female member's contact banana pin 310), is aligned to be inserted into the bore of the female member and the j-lock pins 318 are aligned for insertion into the j-shaped channels 302a on the female member 204. FIG. 5 illustrates the advancement of the connection and insertion of the male member tip 404 into the bore end of the female member. FIG. 6 illustrates the continued advancement of insertion of the tip 404 into the bore at the point where the j-lock pins 318 enter the j-shaped channels 302a on the female member. FIG. 7 shows further advancement of the j-lock pins 318 along the j-shaped channels 302a. FIG. 8 illustrates the further advancement of the j-lock pins 318 along the j-shaped channels 302a just prior to the point of the portion of the channel perpendicular to the long axis of the connector 122 (herein “vertical curvature”) and beginning of the channel's curvature. At this point the O-ring seal 320 begins to compress. FIG. 9 illustrates the advancement of the j-lock pins 318 along the vertical curvature of the j-shaped channels 302a through rotation of the male member 206 in the direction of the vertical curvature with the aid of the operator's rotation that member through use of a wrench applied to the wrench flats 322. At this point the O-ring seal 320 is fully compressed. FIG. 10 shows further advancement of the j-lock pins 318 along the vertical curvature of the j-shaped channels 302a through further rotation of the male member 206 in the direction of the vertical curvature with the aid of the operator's rotation that member through use of a wrench applied to the wrench flats 322. As shown in FIG. 11, at the point where the j-lock pins 318 reach the end of the vertical curvature of the j-shaped channels 302a through rotation of the male member 206 the wrench flats of the male member 322 are aligned with the wrench flats of the female member 402. As shown in FIGS. 12 and 13, at the point where the j-lock pins 318 reach the end of the vertical curvature of the j-shaped channels 302a the spring force of the compressed O-ring seal 320 causes the j-lock pins 318 to move axially to the locked position end of the j-shaped channels 302a, and the male member 206 moves axially to the uncompressed position of the O-ring seal 320. It is in this position the male and female members are latched and/or locked in place, until an opposing force compresses the O-ring seal 320 and counter-rotation reverses the above described process to unlock, unlatch and disconnect the male and female members. FIGS. 14 and 15 show the connector 122 rotated 45° and 90° degrees upwardly in the view for further perspective of the foregoing features. FIG. 16 shows a full length view of the connector 122 from FIG. 15, with holes 1602 for cable position locking set screws. FIG. 17 shows the connector 122 in FIG. 16 rotated by 90° upward in the view.

Referring back to FIGS. 3A and 3B, in a preferred embodiment, elastomeric seal gaskets, for example, an O-ring stack configuration 314, are installed such as to electrically insulate wireline current from shorting out through the ground referenced mechanical housings of the unit 122 whenever superfluous drilling fluid contamination is present. The insulating action is complete when the male member 206 is received axially into the female member 204 as would be the case in FIG. 9, with the male member contact insulator face sealing against the installed O-ring stack 314 by compression and thusly block electrical leakage or shorting to the electrically grounded internal surface of the female member 206 via any wet and conductive contamination present, namely—the drilling medium/mud. Also, the male contact insulating component surrounding the receptacle 312 further impedes the electrical conductivity of wet contamination by its wiping action in combination with its face sealing compression onto the O-ring pack off stack 314 as a “wiping” action that occurs as depicted in FIGS. 9-13 as a result of the 90° rotation of the male member 206 during the “J” latching/coupling and electrical contact reception with the female member 204, providing a sealable, “wet” electrical connection.

The present invention, therefore, is well-adapted to carry out the objects and attain the ends and advantages mentioned as well as others inherent therein. While presently preferred embodiments of the invention have been given for the purpose of disclosure, numerous changes in the details of construction, arrangement of parts, will be readily apparent to those skilled in the art and which are encompassed within the spirit of the invention and the scope of the appended claims.

In summary, a person of skill in the art will recognize that this detailed description discloses an exemplary latchable wireline wet connection. The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow. Further, the specification and drawings are to be regarded in an illustrative rather than a restrictive sense.

Having described presently preferred embodiments of the invention, it may be otherwise embodied within the scope of the following claims.

What is claimed is:

1. A latchable electrical wet connection for transmitting electrical signals comprising:
a male member and a female member capable of being joined conductively on one end, and each joined to an electrical conduit on their respective opposite ends,
said male member including,
a bored shaft for supporting an electrical conduit,
said shaft having an annular shoulder, with a seal positioned against said shoulder, an electrical connection positioned in the bore of said shaft and extending from one end of the shaft capable of coacting with and supporting an opposing electrical connection in said female member,
a plurality of j-lock pins connected to said shaft, and
a rotatable seal positioned in said bored shaft opposite of the electrical contact and communicatively connected to said conduit wire,
said female member including,
a bored shaft for supporting an electrical conduit,
an engageable and releasable electrical contact capable of coacting with the electrical contact from the male member,
a plurality of j-shaped channels cut into said bored shaft for receiving said plurality of j-lock pins on said male member shaft, and
a rotatable seal positioned opposite of the electrical contact and communicatively connected to said conduit wire.

2. The wet connection of claim 1 wherein said seal is an O-ring.

3. The wet connection of claim 2 wherein said electrical connection of said male member is an insulated receptacle.

4. The wet connection of claim 3 wherein said electrical connection of said female member is a plug capable of securely fitting in said male member's insulated receptacle.

5. The method of electrically connecting and/or unconnecting a plurality of sections of an electrical conduit, such as a cable connecting a well tool or the like, said method including the steps of:
(a) providing an electric cable having an upper and a lower end;
(b) connecting one end of said electric cable to a receiving end of a member of an electrical connector or an electrically powered tool or measuring device;
(c) connecting the opposite end of said electric cable to a receiving end of a member of an electrical connector;
(d) connecting a male member end of said electrical connector to a female member end of said electrical cable by axially inserting said male member's electrical contact inside of the bore of said female member, and aligning pins on said male member to slidably enter one or more a j-shaped channels in the bore of said female member.
(e) fully inserting said male member until said pins have reached the end of the axial portion of said j-shaped channels;
(f) rotating said male member so that said pins arrive at and latch in the end of said j-shaped channels of said female members; and
(g) reversing steps (d) through (f) to disconnect said electrical connection.
